(19) United States
(12) Patent Application Publication
(10) Pub. No.: US 2006/0017824 A1
(43) Pub. Date: Jan. 26, 2006

(54) Image processing device, image processing method, electronic camera, and scanner

(75) Inventor: Atsushi Kohashi, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 11/183,843

(22) Filed: Jul. 19, 2005

(30) Foreign Application Priority Data
Jul. 23, 2004 (JP) 2004-215531

(51) Int. Cl. H04N 5/217

(52) U.S. Cl. 348/241

(57) ABSTRACT

In order to make it possible to reduce the noise which is generated in an imaging device 1 in an accurate manner, after the dark current noise has been eliminated from the signal from the imaging device 1 by a black level compensation section 2, noise reduction processing is performed by a noise reduction section 3 and elimination of shot noise is performed, and subsequently white balance compensation is performed by a white balance compensation section 4. When noise reduction processing is performed with this type of structure, it becomes possible to reduce the noise in an accurate manner, since the noise reduction is performed after the black level compensation and moreover before the white balance compensation.

### BACKGROUND OF THE INVENTION

1. Field of the Invention

The present invention relates to an image processing device, an image processing method, and to applied apparatuses such as an electronic camera and a scanner, and more particularly, the present invention relates to an image processing device, an image processing method, and applied devices which perform black level compensation, noise reduction, and gain multiplication processing—for example, white balance compensation—upon images.

Priority is claimed on Japanese Patent Application No. 2004-215531, filed Jul. 23, 2004 the content of which is incorporated herein by reference.

2. Description of Related Art

In an image processing device which improves picture quality by digital image processing of an image signal which is obtained from an imaging device such as a CCD (Charge Coupled Device) or the like, one method of such picture quality improvement processing is noise reduction processing, in which noise included in the image is reduced.

Although there are various causes by which the noise included in the image may be generated, among these, in particular, the influence of noise which originates within the imaging device is great. Since there is a possibility that this noise component which has been generated by the imaging device may be increased by subsequent image processing, such as, for example, edge emphasis processing or tone conversion processing or the like, accordingly noise reduction processing is often processed in an early stage of the image processing.

For example, in a patent document (Japanese Unexamined Patent Application, First Publication No. 2003-101815), a noise reduction device is disclosed which processes noise reduction after having processed at least one of black level compensation and white balance compensation upon the input data, and which thereafter processes various types of image processing.

Concretely, in the above patent document, an embodiment is disclosed in which, as shown in FIG. 13, after having performed black level compensation with a black level compensation section 102 upon the input image data from an imaging device 101, and having performed white balance compensation thereupon with a white balance compensation section 103, noise reduction processing is processed with a noise reduction section 104, and thereafter various other types of image processing are processed by another image processing section 105.

Accordingly, this manner makes it possible to reduce the noise more effectively, since, in this manner, the noise is reduced in an early stage at which the nature of the noise has not as yet been changed.

The main elements among the noise component which are generated in the imaging device are dark current noise and shot noise. Dark current noise is the noise which is generated due to heat even if no light is falling upon the imaging device. Such dark current noise is almost of a constant level and which is independent from the position upon the image, and the dark current noise is added to the image of the object which really is to be photographed. Due to this, when such dark current noise is generated, the brightness of the entire image is increased, and in particular, the black level of the image is no longer “0”, so that the inconvenience that dark parts become grayish occurs.

On the other hand, since shot noise is a phenomenon which takes place in accordance with fluctuations in accuracy, and which occurs during photoelectric conversion, it appears as random noise in the image. Furthermore, since the amount of these fluctuations is proportional to the square root of the number of light quanta, the actual amount of the shot noise itself becomes larger as the number of light quanta becomes greater, in other words, as the amount of light which is incident upon the imaging device becomes greater. For example if it is supposed that the image signal output level value is 100 when the amount of incident light is 100, then, since there is a possibility that shot noise of level 10 can occur, accordingly the value of the output level of the image signal can vary between 90 and 110. On the other hand, when the amount of incident light is 10000, the shot noise value becomes 100, so that the value of the output level of the image signal may vary between 9900 and 10100.

The shot noise constitutes the noise component which exerts the greatest influence upon the image, since, in general, it is harder to reduce the shot noise than to reduce the dark current noise, and since also the shot noise is larger than the dark current noise.

Since there is a relationship between the shot noise and the number of light quanta, the amount of shot noise which is generated varies, not only according to the intensity of the light, but also according to the area per each picture element of the imaging device, and furthermore it also varies according to the photoelectric transfer characteristics of the imaging device and the characteristics of the color filter which is being employed. That is to say, the amount of the shot noise is a value which varies for each different imaging device, and is not something which can be determined upon overall.

FIG. 14 shows the relationship of the amount of shot noise with respect to the amount of incident light for each color filter of an imaging device, as measured by the present inventors. In FIG. 14, the picture element signal level is shown along the horizontal axis, and the shot noise value is shown along the vertical axis. As will be understood from the characteristic shown in FIG. 14, the shot noise value becomes larger as the amount of incident light, that is to say, the image signal level, becomes greater, and furthermore, the characteristic of the shot noise value is different for each of the R, G, and B color filters.

Accordingly, in order to reduce the noise which is caused in the imaging device, solutions can be considered in which the characteristics, as shown in FIG. 14, of variation of the shot noise with respect to change of the amount of light which is incident upon the imaging device and the color filter are determined in advance, and so called reduction processing of the shot noise is performed based upon these characteristics.

### SUMMARY OF THE INVENTION

The first aspect of the present invention is an image processing device which obtains a black level compensation section which performs black level compensation upon image data from an imaging device, a noise reduction section which reduces noise in the image data after the black level compensation, based upon a noise value which corresponds to signal level of the image data, and a gain multiplication processing section which performs gain multiplication processing upon the image data after the noise reduction.

The second aspect of the present invention is an image processing device according to the first aspect in which the noise reduction section obtains a noise value calculation section which stores a noise characteristic of the imaging device.

The third aspect of the present invention is an image processing device according to the first aspect in which the gain multiplication processing section is a white balance compensation section which performs white balance compensation.

The fourth aspect of the present invention is an image processing method, which obtains a black level compensation step in which black level compensation upon image data from an imaging device is performed, a noise reduction step in which noise reduction in the image data after the black level compensation, based upon a noise value which corresponds to signal level of the image data, is performed, and a gain multiplication processing step in which gain multiplication processing upon the image data after noise reduction is performed.

The fifth aspect of the present invention is an electronic camera which obtains an imaging device which converts light which is incident via a lens into an electrical signal, an image processing device according to the first aspect, and an external output section which converts an output signal from said image processing device into a predetermined format and outputs it to the exterior.

The sixth aspect of the present invention is a scanner which obtains an imaging device upon which picture elements are arranged along one direction, an image processing device according to claim 1, and an external output section which converts an output signal from said image processing device into a predetermined format and outputs it to the exterior.

### BRIEF DESCRIPTION OF THE DRAWINGS

FIG. 1 is a block diagram showing the structure of the first embodiment of the present invention.

FIG. 2 is a block diagram showing the structure of a noise reduction section of this first embodiment of the present invention.

FIG. 3 is a graph which is used in the explanation of a noise value calculation section of the first embodiment of the present invention.

FIG. 4 is an explanatory figure showing an imaging device of a Bayer array.

FIG. 5A is an explanatory figure for a data generation section.

FIG. 5B is an explanatory figure for a data generation section.

FIG. 6A is another explanatory figure for the data generation section.

FIG. 6B is another explanatory figure for the data generation section.

FIG. 7A is another explanatory figure for the data generation section.

FIG. 7B is another explanatory figure for the data generation section.

FIG. 8A is another explanatory figure for the data generation section.

FIG. 8B is another explanatory figure for the data generation section.

FIG. 9 is a flow chart for use in the explanation of the second embodiment of the present invention.

FIG. 10 is a flow chart for use in the explanation of a noise reduction step in the second embodiment of the present invention.

FIG. 11 is a block diagram showing the structure of an electronic camera according to the third embodiment of the present invention.

FIG. 12 is a block diagram showing the structure of a scanner according to the fourth embodiment of the present invention.

FIG. 13 is a block diagram showing an example of a prior art type image processing device.

FIG. 14 is a graph for use in the explanation of the shot noise characteristic.

### DETAILED DESCRIPTION OF THE INVENTION

In the following, various embodiments of the present invention are explained with reference to the appended drawings.

### THE FIRST EMBODIMENT

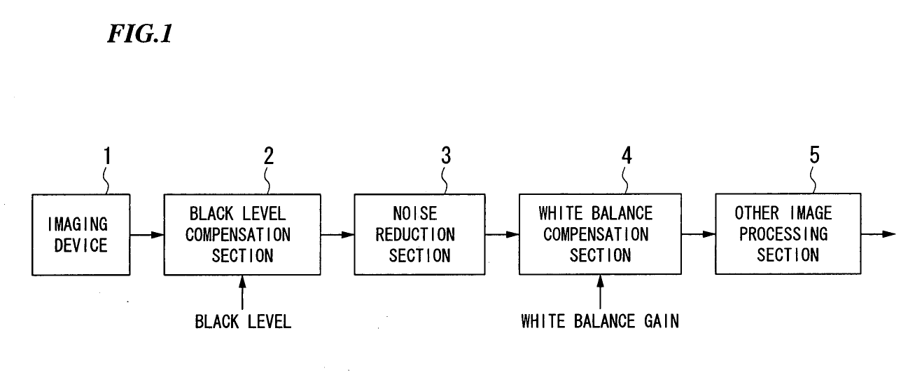

FIG. 1 is a block structure diagram showing the structure of an image processing device according to the first embodiment of the present invention. In this figure, the reference symbol 1 denotes an imaging device, 2 denotes a black level compensation section which subtracts the dark current component which is included in the image, 3 denotes a noise reduction section which reduces the shot noise which is included in the image, 4 denotes a white balance compensation section which compensates the white balance of the image, and 5 denotes another image processing section which performs color compensation, tone correction, resolution correction, or the like of the image. It should be understood that certain blocks which are necessary for the actual hardware structure of this device, such as memory, a CPU (Central Processing Unit), a memory controller, and so on are omitted from this figure, since they are not related to the essence of the present invention.

Image light from the object which is being photographed is photo-electrically converted by the imaging device 1 of FIG. 1. As this imaging device 1, for example, a CCD (Charge Coupled Device) imaging device in which color filters of three primary colors R (red), G (green), and B (blue) are arranged in a Bayer array is used. The image signal which has been photo-electrically converted by the imaging device 1 is converted into a digital signal by an A/D (Analog to Digital) conversion circuit (not shown in the figures), and the resulting digital image signal is input by the black level compensation section 2 one picture element at a time.

In the black level compensation section 2, the inconvenience that dark parts of the image become grayish is compensated by subtracting, from the image data, a black level which has been output from a dark current detection section (not shown in the figures) which detects the dark current of the imaging device 1.

The image signal upon which black level compensation has thus been performed by the black level compensation section 2, is supplied to the noise reduction section 3. In this noise reduction section 3, reduction processing of the shot noise is performed.

The image signal which has been noise reduced by the noise reduction section 3 is supplied to the white balance compensation section 4. In this white balance compensation section 4, white balance compensation is performed by multiplying each of the three signals of the colors R, G, and B by the white balance gain for each of them. The resultant signal which has been white balance compensated is output to the image processing section 5, and the image processing section 5 performs some other type of processing, such as color compensation or tone correction or the like to the image signal.

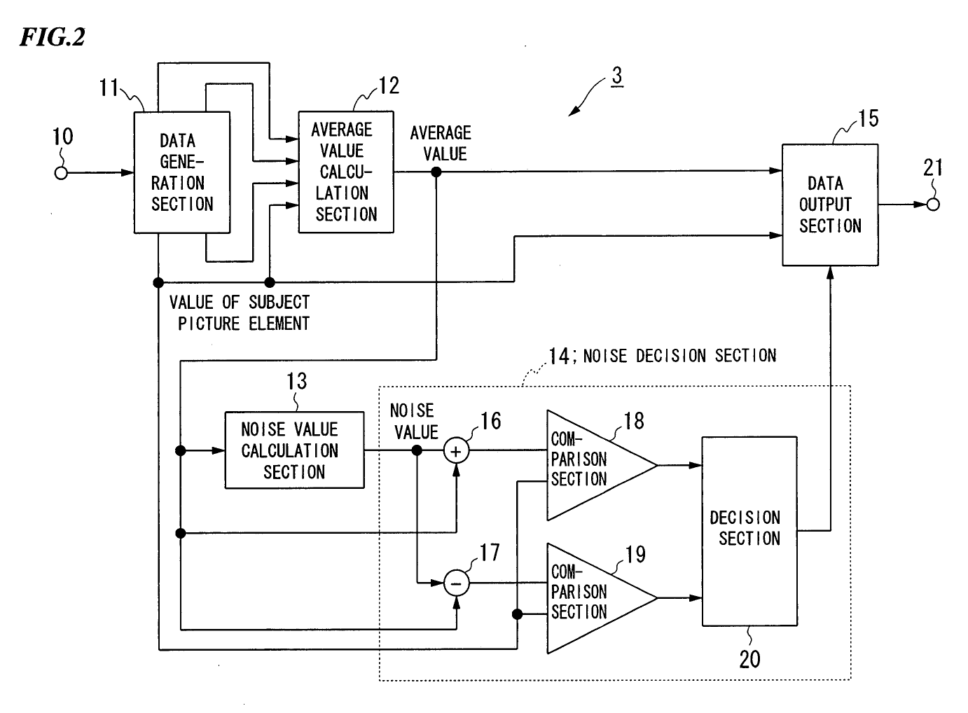

FIG. 2 shows the structure of the noise reduction section 3. As shown in this figure, the noise reduction section 3 obtains a data generation section 11 which converts the image data after black level compensation into (n×m) two dimensional image data, an average value calculation section 12 which calculates the average value of this two dimensional image data, a noise value calculation section 13 which calculates a noise value for each picture element based upon the noise characteristics of the imaging device 1, a noise decision section 14 which decides whether or not to perform noise reduction for a picture element to which attention is being directed, and a data output section 15 which selects the output data based upon the result of the decision made by the noise decision section 14. The noise value calculation section 13 stores the noise characteristic of the imaging device 1 internally.

In FIG. 2, the signal from an input terminal 10 is supplied to a data generation section 11. In this data generation section 11, for example, a (3×3) two dimensional image signal is generated from the image signal which has been input, and the image signals of the four comers of this two dimensional array are output.

In other words, if, for example, a Bayer array type element is used as the imaging device 1, then, as shown in FIG. 4, the picture element signals R, Gr, R, Gr, . . . and the picture element signals Gb, B, Gb, B, . . . are obtained from the imaging device 1 one line at a time.

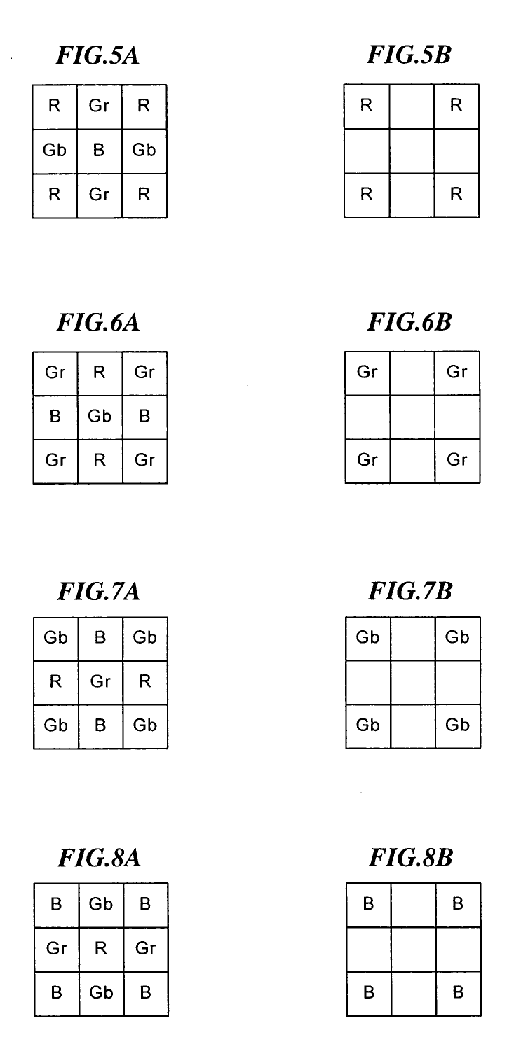

When generating a (3×3) two dimensional picture element signal in this manner from the picture elements of this type of Bayer array, a picture element array pattern as shown in FIG. 5A may occur, a picture element array pattern as shown in FIG. 6A may occur, a picture element array pattern as shown in FIG. 7A may occur, or a picture element array pattern as shown in FIG. 8A may occur.

If the picture element array pattern comes to be as shown in FIG. 5A, then, when the picture element signals of the four picture elements which are at the four corners of the pattern are output, it is possible to obtain four R (red) picture element signals, as shown in FIG. 5B. If the picture element array pattern comes to be as shown in FIG. 6A, then, when the picture element signals of the four picture elements which are at the four corners of the pattern are output, it is possible to obtain four Gr (green in a red series) picture element signals, as shown in FIG. 6B. If the picture element array pattern comes to be as shown in FIG. 7A, then, when the picture element signals of the four picture elements which are at the four corners of the pattern are output, it is possible to obtain four Gb (green in a blue series) picture element signals, as shown in FIG. 7B. And, if the picture element array pattern comes to be as shown in FIG. 8A, then, when the picture element signals of the four picture elements which are at the four corners of the pattern are outputted, it is possible to obtain four B (blue) picture element signals, as shown in FIG. 8B.

Returning to FIG. 2, the output of the data generation section 11 is supplied to the average value calculation section 12. In the average value calculation section 12, an average value signal is calculated for the four picture elements which have been output from the data generation section 11.

In this first embodiment of the present invention, the data generation section 11 outputs four picture elements, therefore, the calculation which is performed in the average value calculation section 12 is a simple average of these four picture elements, however, it would also be possible for the data generation section 11 to output any number of picture elements of the same color, in which case the average value calculation might not be a matter of simple averaging—it might alternatively be a calculation of a weighted average value.

Along with the output of the average value calculation section 12 being supplied to the data output section 15, it is also supplied to the noise value calculation section 13. The noise value calculation section 13 calculates a noise value, based upon the average value signal from the average value calculation section 12.

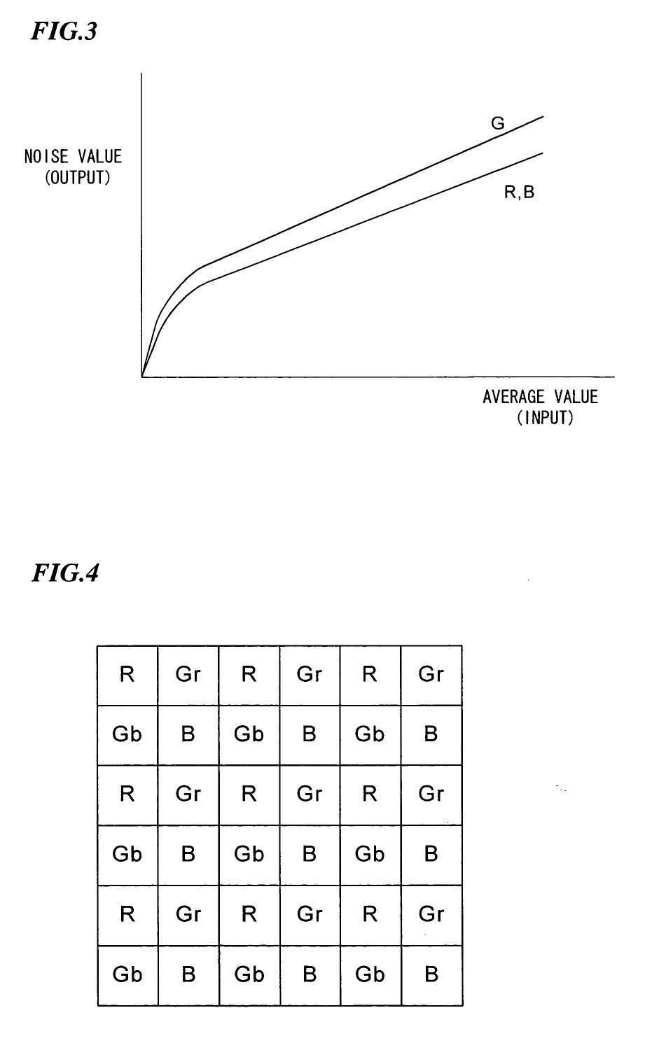

Here, the noise characteristic of the imaging device 1 which is stored in the noise value calculation section 13 is formulated based upon the shot noise value with respect to the image signal level which has been obtained in advance by experiment. For example, if it is supposed that a characteristic such as the one shown in FIG. 3 has been obtained as the characteristic of the shot noise value with respect to the image signal level, then, from this characteristic, a lookup table is constructed by taking the average value of the image signal as the input, and by taking the shot noise value (the noise value) as the output, and this lookup table is provided in the noise value calculation section 13.

In FIG. 3, the picture element signal level is shown along the horizontal axis, and the noise value is shown along the vertical axis. Here, with the noise characteristic shown in FIG. 3, the noise value is zero when the picture element signal value is zero, but this is because, before performing the noise reduction processing, the black level compensation has been performed. Since this shot noise is different depending upon the characteristics of the RGB color filter, the lookup table is provided in the noise value calculation section 13 for output of a noise value corresponding to the level of the image signal, for each of the R picture elements, Gr picture elements, Gb picture elements, and B picture elements.

Although, in the example described above, the noise value calculation section 13 is arranged to obtain a noise value from the picture element signal level by using a lookup table, the present invention is not limited to a method which utilizes a lookup table. It would also be acceptable, as an alternative, to divide the noise characteristic curve into a number of straight line segments, and to store the parameters of these straight line segments in registers, so as to be able to obtain the noise value by calculation.

In FIG. 2, the noise value which has been obtained by the noise value calculation section 13 is sent to the noise decision section 14. A decision is made by this noise decision section 14 as to whether or not noise reduction processing should be performed for the subject picture element to which attention is currently being directed.

The noise decision section 14 obtains an addition section 16 which adds together the average value and the noise value, a subtraction section 17 which subtracts the noise value from the average value, a comparison section 18 which compares together the value which has thus been obtained by adding together the average value and the noise value and the value for the subject picture element, another comparison section 19 which compares together the value which has been obtained by subtracting the noise value from the average value and the value for the subject picture element, and a decision section 20 which makes a decision as to whether or not to perform noise reduction processing for the subject picture element, based upon the output from the first comparison section 18 and the output from the second comparison section 19. Here, by the subject picture element is meant the picture element for which it is being contemplated to perform noise reduction processing, and this is one picture element among the four picture elements which are output from the data generation section 11.

The decision section 20 uses the outputs of the first comparison section 18 and the second comparison section 19, and makes this decision as to whether or not to perform noise reduction processing for the subject picture element.

That is to say, the decision section 20 performs the following two judgments for the subject picture element.
(1) Subject picture element level<(average value+noise value)
(2) Subject picture element level>(average value−noise value)

The meaning of these two judgments is as follows.

The average value on the right sides of these two judgment conditions is regarded as the signal from which the high frequency components such as random noise have been eliminated, that is to say, the signal not including noise. Furthermore, the noise value is the shot noise value which is generated when the output of the imaging device is at the average value signal level.

Hence, the value (average value+noise value) in the judgment condition (1) can be taken as being an upper limit value for the picture element level if noise is included in the subject picture element. In other words, if the result of the judgment condition (1) is TRUE, i.e. if the subject picture element level is less than (average value+noise value), then this means that the possibility is high that a shot noise component is included in the subject picture element. Conversely, if the result is FALSE, then this means that, although noise may be included, the subject picture element is at a portion of the image at which the level changes by more than the noise value, such as for example an edge portion of the object being photographed, or the like.

In the same manner, if the result of the judgment condition (2) is TRUE, then this means that noise is included, while if it is FALSE, this means that the subject picture element is at a portion of the image at which the level changes largely. When P is defined as the result of AND operation between these two judgment results, and if P is TRUE, this indicates that the subject picture element contains a noise component, and moreover is at an uniform portion of the image. If P is FALSE, this indicates that the subject picture element contains a noise component, and moreover is at an edge portion of the image.

The average value from the average value calculation section 12 and the picture element value for the subject picture element from the data generation section 11 are supplied to the data output section 15. And, based upon the judgment result P above, the data output section 15 selects one or the other of the average value signal and the subject picture element signal in the following manner, and outputs it to the output terminal 21.

When P is TRUE: Since this is an even portion in which noise is included, the average value signal is selected and is output to the data output section 15.

When P is FALSE: Since, if the average value signal is output, this edge portion may undesirably be softened due to the low pass effect. Therefore, the subject picture element is selected and is output from the data section 15, although noise can be included.

By performing this type of judgment, it is possible to distinguish in an accurate manner whether this is a location within the image at which the change of level is due to noise, or whether it is a location at which the change of level is due to the actual pattern of the object to be photographed; and, as a result, it becomes possible to perform the noise reduction processing with good accuracy.

Although, in this first embodiment of the present invention, the construction is such that one or the other of the average value signal and the subject picture element signal is output as the output signal of the noise reduction processing, the present invention is not to be considered as being limited by this feature; it would be acceptable to utilize any desired method, provided that the construction was one in which the noise was reduced based upon the noise characteristic of the imaging device which was measured in advance. Furthermore, although this embodiment has been explained in terms of an example in which a Bayer type RGB filter was employed as the color filter for the imaging device, it goes without saying that this feature is not intended to be limitative of the present invention.

As being explained above, in this first embodiment of the present invention, it is arranged, after the dark current noise has been eliminated by the black level compensation section 2, for elimination of the shot noise to be performed by the noise reduction section 3, and subsequently the white balance compensation is performed by the white balance compensation section 4. By performing the noise reduction processing with this type of structure, it becomes possible to reduce the noise while keeping the edges of the image of the object to be photographed. Furthermore, since the noise reduction is performed after the black level compensation and moreover before the white balance multiplication, accordingly it becomes possible to perform the noise reduction in an accurate manner.

### THE SECOND EMBODIMENT

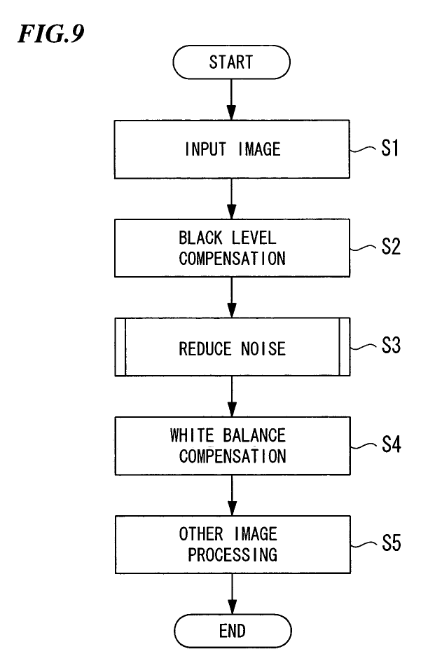

FIG. 9 is a figure showing the second embodiment of the present invention. This second embodiment is one in which the processes of the first embodiment described above are implemented in software. In the flow chart of FIG. 9, first, in an image input step S1, the digital image data is read. In a case such as which, for example, digital image data which has been photographed by an imaging device have been stored in advance in the memory of a computer, this is a step in which this image data is read from that memory.

Next, in a black level compensation step S2, dark parts of the image which has become grayish is compensated according to a procedure which is the same as in the first embodiment described above.

Next, in a noise reduction step S3, reduction processing of the shot noise is performed. Then, in a white balance compensation step S4, the image signal which has been noise reduced in the noise reduction step S3 is multiplied by white balance gain for each of R, G, and B components. Since, at this time, noise reduction has already been performed upon each of the R, G, and B signals, accordingly the noise component is not increased, even though this gain multiplication is performed.

Then the image signal which has thus been white balance compensated is subjected to various types of processing in another image processing step S5, such as color compensation and tone correction.

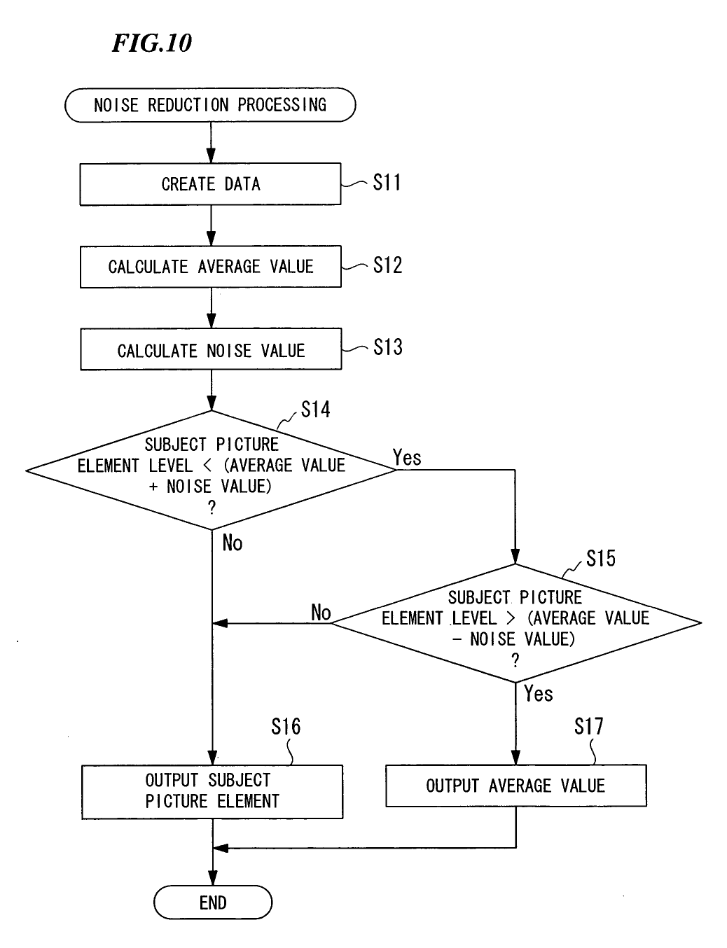

FIG. 10 is a figure showing in detail the procedures in the noise reduction step S3. In this noise reduction step S3, as shown in FIG. 10, first, in a data creation step S11, two dimensional (3×3) image data of the picture elements is extracted, and the four picture elements at the four comers thereof are output. Next, in an average value calculation step S12, the average value of these four picture elements is calculated. Next, in a noise value calculation step S13, the noise value is calculated by the same procedure as in the first embodiment described above, based upon the average value signal.

Next, in the first noise judgment step S14, a judgment is made such as “the subject picture element level<(the average value+the noise value)”. If the result of this judgment is YES, in other words, if the subject element picture level is indeed smaller than (the average value+the noise value), then proceeds to the second noise decision step S15. On the other hand, if the result of this judgment is NO, in other words, if the subject element picture level is greater than (the average value+the noise value), then it is determined that this subject picture element is an edge portion of the image, and accordingly (in a step S16) the subject picture element is output.

Next, in the second noise judgment step S15, a judgment is made such as “the subject picture element level>(the average value—the noise value)”. If the result of this judgment is YES, in other words, if the subject element picture level is indeed greater than (the average value—the noise value), then, since the subject picture element level has now been determined to be between (the average value+the noise value) and (the average value—the noise value), accordingly it is determined that this subject picture element is not an edge portion of the image, and the average value is output (in step S17).

On the other hand, if the result of this judgment is NO, in other words, if the subject element picture level is less than (the average value—the noise value), then it is determined that this subject picture element is an edge portion of the image, and accordingly (in step S16) the subject picture element is outputted.

It is, of course, possible to implement each of the procedures in this flow chart by a computer program, and thereby to execute the present invention using a computer, i.e. in software.

### THE THIRD EMBODIMENT

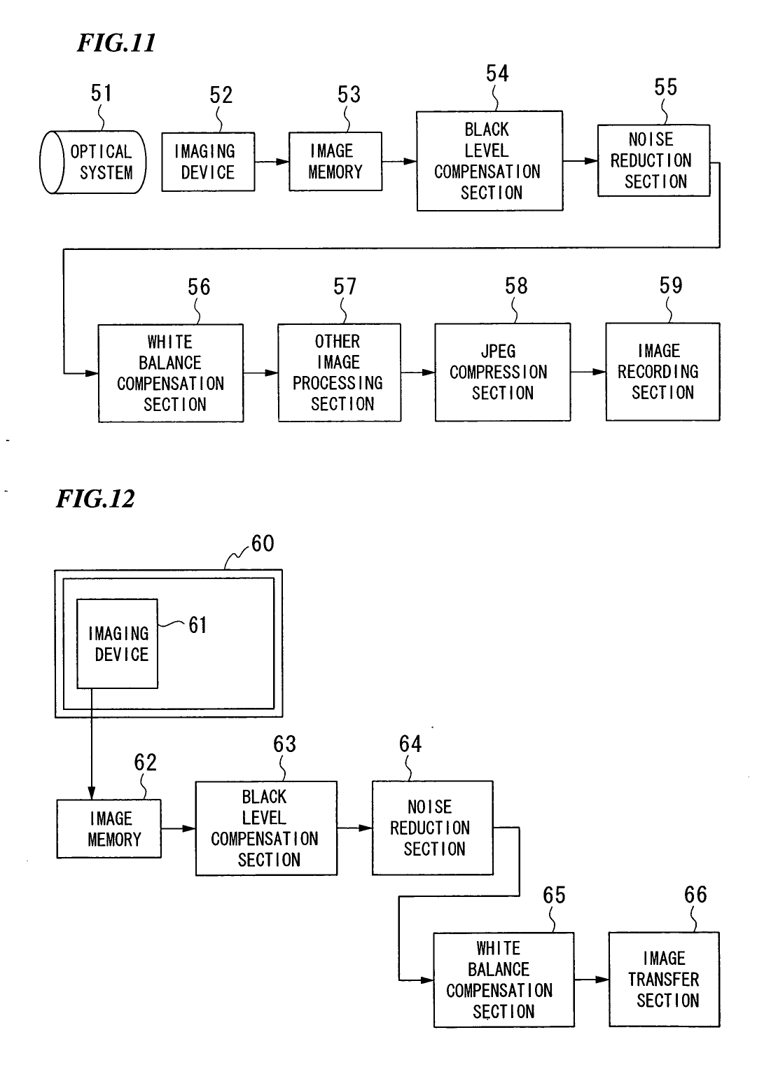

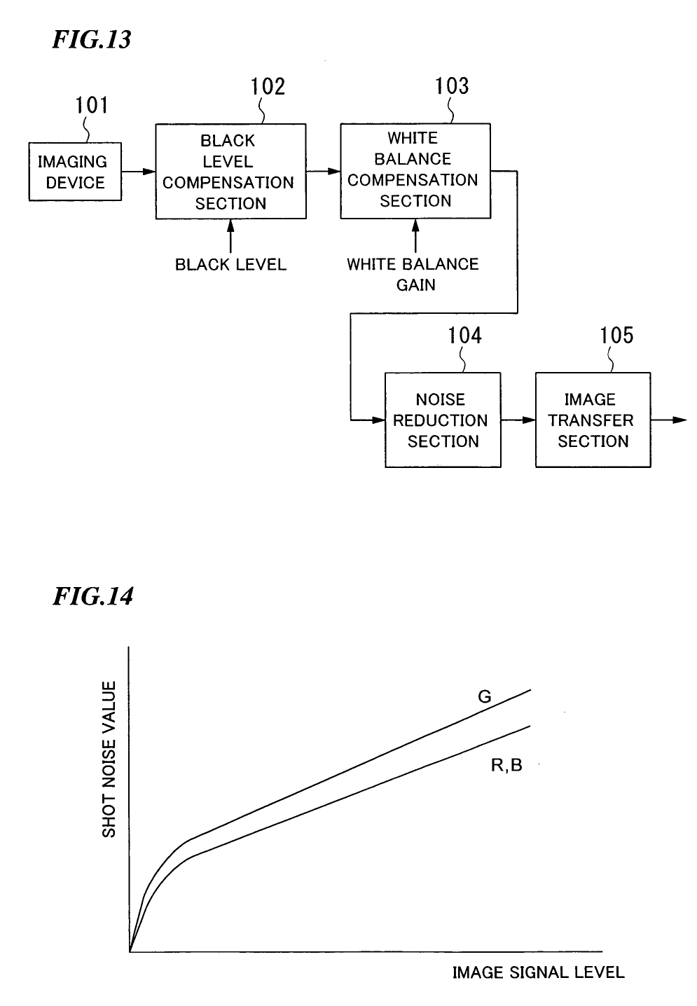

Next, a third embodiment of the present invention is explained. FIG. 11 is a figure showing this third embodiment of the present invention. This third embodiment is one in which the first embodiment described above is applied to an electronic camera.

In FIG. 11, the reference symbol 51 denotes an optical system, and 52 denotes an imaging device. A CCD imaging device is used for this imaging device 52. An image of the object to be photographed is imaged upon the light reception surface of the imaging device 52 via the optical system 51, and the image of the object to be photographed is photoelectrically converted by the imaging device 52. The image signal which has thus been photoelectrically converted by the imaging device 52 is converted into a digital signal by an A/D conversion circuit (not shown in the figures), and is stored in an image memory 53.

The image signal which has been read from the image memory 53 is supplied to a black level compensation section 54. In this black level compensation section 54, dark parts of the image that has become grayish is compensated by subtracting from the image data a black level which has been output from a dark current detection section which detects the dark current of the imaging device 52. The image signal which has thus been black level compensated by the black level compensation section 54 is supplied to a noise reduction section 55. In the noise reduction section 55, reduction processing of the shot noise is performed.

The image signal which thus has been noise reduced by the noise reduction section 55 is supplied to a white balance compensation section 56. In this white balance compensation section 56, each of the three R, G, and B color signals is multiplied by its own corresponding white balance gain, so as to perform white balance compensation. The image signal which has thus been white balance compensated is transferred to an image processing section 57, and, in this image processing section 57, various other types of processing are performed, such as color compensation and tone correction. And then the image is compressed by a JPEG (Joint Photographic Experts Group) compression section 58, and is recorded in an image recording section 59.

With the above described structure, it is possible to implement an electronic camera which obtains images of high picture quality in which the noise is reduced.

### THE FOURTH EMBODIMENT

Next, the fourth embodiment of the present invention is explained. FIG. 12 is a figure showing this fourth embodiment of the present invention. This fourth embodiment is one in which the first embodiment described above is applied to a scanner.

In FIG. 12, the reference symbol 60 denotes a document table, while 61 denotes an imaging device in which picture elements are arranged along a single line. An image of a document which is lying upon the document table 60 is read by the imaging device 61 shifting along the document table 60, and scanning the image. After having been subjected to A/D conversion (by a means not shown in the figure), this image data is stored in an image memory 62.

The image signal which has been read from the image memory 62 is supplied to a black level compensation section 63. In the black level compensation section 63, black parts of the image that has become grayish is compensated by subtracting from the image data a black level which has been output from a dark current detection section which detects the dark current of the imaging device 61. The image signal which has thus been black level compensated by the black level compensation section 63 is supplied to a noise reduction section 64. In this noise reduction section 64, reduction processing of the shot noise is performed.

The image signal which has thus been noise reduced by the noise reduction section 64 is supplied to a white balance compensation section 65. In this white balance compensation section 65, each of the three R, G, and B color signals is multiplied by a white balance gain, and thereby white balance compensation is performed. And the image signal is transferred to the outside by an image transfer section 66.

By utilizing the above described structure, it is possible to implement a scanner which obtains images of high picture quality in which the noise has been reduced.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An image processing device, comprising:
a black level compensation section which performs black level compensation upon image data from an imaging device;
a noise reduction section which reduces noise in said image data after said black level compensation, based upon a noise value which corresponds to signal level of said image data; and
a gain multiplication processing section which performs gain multiplication processing upon said image data after said noise reduction.

2. An image processing device according to claim 1, wherein
the noise reduction section comprises a noise value calculation section which stores a noise characteristic of said imaging device.

3. An image processing device according to claim 1, wherein said gain multiplication processing section is a white balance compensation section which performs white balance compensation.

4. An image processing method, comprising:
a black level compensation step in which black level compensation is performed to image data from an imaging device
a noise reduction step in which noise reduction is performed to the image data compensated in said black level compensation step, based upon a noise value which corresponds to signal level of the image data; and
a gain multiplication processing step in which gain multiplication processing is performed to the image data whose noise was reduced in said noise reduction step.

5. An electronic camera, comprising:
an imaging device which converts light which is incident via a lens into an electrical signal;
an image processing device according to claim 1; and
an external output section which converts an output signal from said image processing device into a predetermined format and outputs it to the exterior.

6. A scanner, comprising:
an imaging device upon which picture elements are arranged along one direction,
an image processing device according to claim 1, and
an external output section which converts an output signal from said image processing device into a predetermined format and outputs it to the exterior.
